(19) United States
(12) Patent Application Publication
(10) Pub. No.: US 2025/0153466 A1
(43) Pub. Date: May 15, 2025

(54) Recyclable Film Food Packaging with Laser Date Coding

(71) Applicant: General Mills, Inc., Minneapolis, MN (US)

(72) Inventors: Kayla Bowe, Grafton, WI (US); Brett Daniel Heffelbower, Minneapolis, MN (US)

(73) Assignee: General Mills, Inc., Minneapolis, MN (US)

(21) Appl. No.: 18/389,401

(22) Filed: Nov. 14, 2023

(51) Int. Cl. B32B 27/08; B32B 1/00; B32B 3/30; B32B 7/02; B32B 27/30; B32B 27/32; B65B 25/00; B65B 61/02; B65D 75/00; B65D 75/26; B65D 75/58

(52) U.S. Cl. CPC B32B 27/08; B32B 1/00; B32B 3/30; B32B 7/02; B32B 27/306; B32B 27/32; B65B 25/00; B65B 61/025; B65D 75/008; B65D 75/26; B65D 75/5805; B32B 2255/10; B32B 2307/4023; B32B 2307/516; B32B 2307/518; B32B 2439/70

(57) ABSTRACT

A packaged food product includes a food product in packaging formed from a polyethylene film laminate body having a main polyethylene (PE) film layer and an ethylene vinyl alcohol (EVOH) layer. The packaging is laser date coded, with the laser date coding being established in the EVOH layer. Of the overall packaging, the ethylene vinyl alcohol layer is quite thin, generally having a thickness which is no greater than 5% of a thickness of the food packaging. The entire food packaging is readily recyclable, particularly by being at least essentially void of any polypropylene polymers and polyethylene terephthalate. The EVOH layer can be the outermost layer of the packaging, such as with the packaging being limited to just the PE and EVOH layers, or the packaging can include one or more other layers, such as cold seal, tie and/or ink layers.

### FIELD OF THE INVENTION

The invention generally pertains to the art of food packaging and, more particularly, enhancing laser date coding on food packaging made from recyclable film.

### BACKGROUND OF THE INVENTION

Employing flexible film for packaging a wide range of food is widely known in manufacturing various packaged food products. In particular, packaging systems employing films include, but not limited to, vertical form, fill and seal (VFFS) packaging systems, horizontal form, fill and seal (HFFS) packaging systems, horizontal flow wrap (HFW) packaging systems and gusset bag forming systems which are often used in packaging various food snacks, including cereal, potato chips, power bars, breakfast bars, dry mixes and the like. In general, these packaging systems can rely on wrapping and sealing food products in a flexible film taken from a roll or forming of a flexible package, such as a gusseted pouch, which is filled with a food product and then sealed. One or more packaged products are often further packaged in a box for shipment to a retail store in order to be sold to consumers.

Collectively, all of these known packaging systems could be generically referred to as film packaging systems. The films employed in at least the food packaging field are laminates, mainly consisting of polypropylene (specifically biaxially oriented polypropylene or BOPP), polyethylene (specifically biaxially oriented polyethylene or BOPE), polyethylene terephthalate (PET) or a combination thereof. Of these known films, polyethylene (PE) films are often favored based on their ability to be readily recycled.

In the packaging of food, date coding the packaging, which includes product use by, sell by, made on, expiration and the like dates, must often be employed to assure the quality of the food to be consumed. One known method of date coding food product packaging is laser date coding, such as employing CO₂ laser coding. Unfortunately, laser date coding, including CO₂ laser date coding, is simply not effective on PE film. More specifically, the laser coding is employed to etch the film to a specified depth utilizing a laser, with the etching intended to create readily readable dates on the packaging. However, specifically with PE films, the resulting dating is very difficult to visually discern, even in the best of lighting.

With the above in mind, there is seen to be a need for a flexible PE film laminate, particularly available in roll form for the food packaging industry, which is structured to enable laser coding to be effectively employed, while still having the overall package completely, readily recyclable.

### SUMMARY OF THE INVENTION

In accordance with the invention, a food packaging having laser date coding is made from a flexible laminate packaging film specifically formed from only materials which can be readily recycled, specifically post consumer recycled (PCR). More specifically, the overall film of the packaging includes a main laminate body constituted by a polyethylene (PE) film layer and an ethylene vinyl alcohol (EVOH) layer, with the laser date coding being created in the EVOH layer. In particularly preferred embodiments of the invention, the EVOH layer is quite thin, i.e., no greater than 5% of the thickness of the food packaging. With this overall arrangement, laser date coding can be effectively employed to create a readily readable coding date in the EVOH layer in an overall packaging film which is readily recyclable. More specifically, although additional layers can be included in the overall film, such as a cold seal, tie layer and/or an ink layer, the film is at least essentially void of, and preferably entirely void of, polypropylene (PP) and polyethylene terephthalate (PET), thereby being significantly advantageous in creating food packages which are readily recyclable which requires, in accordance with the invention, the film to meet various specific criteria. The film can advantageously be provided in roll form for use in a wide range of film flow food packaging systems to establish various types of food packages with readily readable date coding.

Additional objects, features and advantages of the invention will become more readily apparent from the following detailed description, when taken in conjunction with the drawings wherein like reference numerals refer to corresponding parts in the several views.

### BRIEF DESCRIPTION OF THE DRAWINGS

FIG. 1 illustrates an exemplary dry mix gusseted food pouch made from readily recyclable laminate polyethylene film having laser date coding in accordance with the invention; and

FIG. 2 is a cross-sectional view of layers of the recyclable laminate polyethylene film of FIG. 1.

### DETAILED DESCRIPTION OF EMBODIMENTS

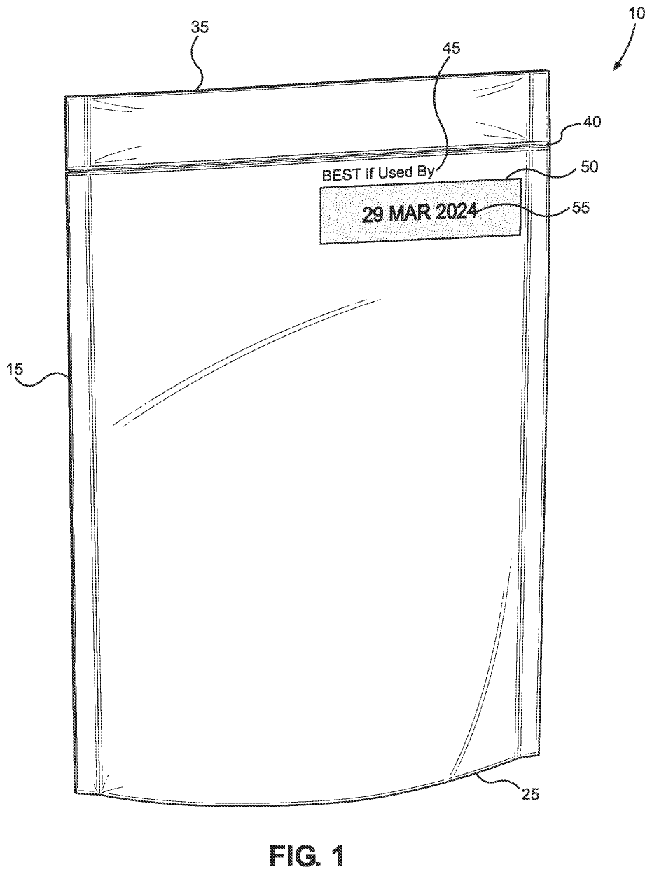

With initial reference to FIG. 1, the invention will be described with respect to establishing a readily recyclable packaged food product which is generally shown in FIG. 1 at 10 and made from a polyethylene film laminate 15. At this point, it should be noted that recyclability is measured according to standard testing protocol, particularly APR Critical Guidance Protocol FPE-CG-01. Important in accordance with the invention, constituting an entirely, “readily recyclable” food package requires polyethylene film laminate 15 to meet various criteria. That is, constituting a recyclable material can take various meanings in the art, even inclusive of a material which can be reformed into an extrudable product that is not functional for its original purpose (often referred to as down recycling). Also, various materials can be recycled only through chemical processing. In accordance with the present invention, “readily recyclable” means film 15 can be mechanically recycled according to ISO standards back to a PE film usable for its original purpose. In addition, it is important to recognize that this definition must encompass post consumer recycling, i.e., where the film is collected through consumers and recycled (Post Consumer Recycled or PCR) according to ISO standards, particularly ISO 14021:2016 Section 7.8.1. That is, it is not enough for excess material during original film manufacturing to be easily recycled, but rather the film must be recyclable after film 15 is used to package a product and the product packaging is later sent for recycling by a consumer. To meet these specifically defined criteria, as indicated above, it is important that the entire film be void of any polymer which would render the film not readily recyclable, particularly at least essentially void of (i.e., less than 10%) and, more preferably, completely void of polypropylene and polyethylene terephthalate in the film, as this enhances the ease of recycling given at least the differences in known melting temperatures of polypropylene (about 320° F.) and polyethylene terephthalate (about 500° F.) versus polyethylene (less than 270° F.).

With continued reference to FIG. 1, although the food packaging of the invention can take many forms generally manufactured from a film provided in roll form for use in a film flow packaging system to establish packages which envelop food products, packaged food product 10 is shown as a flexible pouch including gusseted bottom portion 25 enabling packaged food product 10 to be supported upright, resting on bottom portion 25, such as on a supermarket shelf. At an upper end 35 of packaged food product 10, a tear strip starting slit 40 is created in order to provide easy access to an interior storage zone for a food product (not shown) such as a dry mix. Since a food product is of concern, the packaging is shown to include a reference to an expiration, such as through a “Best If Used By” phrase 45, as well as a labeling region 50 containing a coded date 55. Important in accordance with the invention is the use of laser date coding, particularly CO₂ laser date coding, such as in labeling region 50. Unfortunately, directly laser coding the polyethylene in polyethylene film laminate 15 does not result in satisfactory laser date coded, i.e., attempting to employ CO₂ laser date coding directly to the polyethylene does not result in a readily readable coded date.

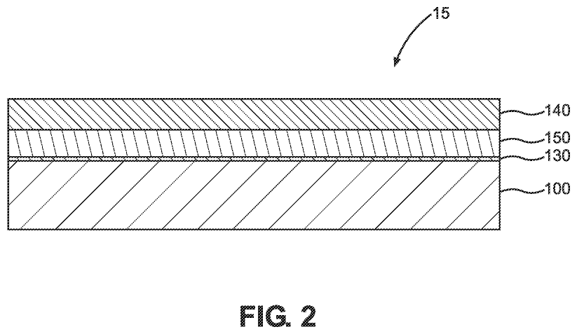

To counter this problem, polyethylene film laminate 15 is specifically structured as will now be described with specific reference to FIG. 2. In accordance with the invention, the laminate polyethylene film 15 includes, at a minimum, a main body layer 100 constituted by a polyethylene film and an ethylene vinyl alcohol (EVOH) layer 130, with ethylene vinyl alcohol layer 130 being quite thin, generally having a thickness which is no greater than 5% of a thickness of the entire food packaging. At this point, it should be understood that, in referring to main body layer 100 as a polyethylene film, it is meant that main body layer 100 is void of any polymer which would render the film not readily recyclable (as defined herein), in particular at least essentially void of (less than 10%) and, more preferably, completely void of polypropylene polymers in the film. The same is true for the entire laminate polyethylene film 15. However, it should be noted that referring to a “film” or “layer” does not mean that each cannot be a laminate with multiple sub-layers. In accordance with certain embodiments of the invention, main body layer 100 is a polyethylene (PE) film, such as oriented polyethylene (OPE), biaxially oriented polyethylene (BOPE), machine direction oriented polyethylene (MDOPE), Blown PE or Cast PE, with an exemplary thickness in the range of 60-200 gauge.

Important in connection with the invention, it is the ethylene vinyl alcohol layer 130 that is subjected to coding, specifically laser date coding and, even more preferably, CO₂ laser date coding. Laser coding ethylene vinyl alcohol layer 130, rather than polyethylene film 100, has been found to significantly enhance the readability of coded date 55 as the crystallinity structure of ethylene vinyl alcohol layer 130 has been found to be highly damaged by the application of the layer, thereby resulting in a highly effective etching operation. With this overall arrangement, laser date coding can be effectively employed to create a readily readable product coded date 55 in the EVOH layer 130 in an overall packaging film 15 which is readily recyclable. Although in certain embodiments of the invention only these two films/layers are required so the EVOH layer 130 is an outermost layer, one or more other layers can be included in the overall film, such as an ink layer 140 to present product information to a consumer and a tie or adhesive layer 150 interconnecting EVOH layer 130 with ink layer 140, as shown in FIG. 2. Even with EVOH layer 130 being between ink layer 140 and polyethylene film 100, the EVOH is particularly susceptible to damage by the laser, advantageously establishing a highly readable date code in accordance with the invention. With this in mind, even other layers, like one or more cold seal layers, can be included, particularly based on the type of packaging being made through the requisite film forming system employed, while still enabling the thin EVOH layer 130 to subjected to etching by a laser.

Although described with reference to preferred embodiments of the invention, it should be understood that various changes and/or modification can be made without departing from the invention.

1. A packaged food product comprising:
a food packaging having an interior, said food packaging being established by a polyethylene laminate body including a main polyethylene film and an ethylene vinyl alcohol layer, wherein said food packaging is readily recyclable;
a food product within the interior of the food packaging; and
a laser date coding etched in the ethylene vinyl alcohol layer of the food packaging.

2. The packaged food product of claim 1, wherein the ethylene vinyl alcohol layer is an outermost layer of the food packaging.

3. The packaged food product of claim 1, wherein ethylene vinyl alcohol layer has a thickness which is no greater than 5% of a thickness of the food packaging.

4. The packaged food product of claim 1, wherein the main polyethylene film is formed of oriented polyethylene (OPE), biaxially oriented polyethylene (BOPE), machine direction oriented polyethylene (MDOPE), Blown PE or Cast PE.

5. The packaged food product of claim 4, wherein the food packaging consists of the main polyethylene film and the ethylene vinyl alcohol layer.

6. The packaged food product of claim 4, wherein the food packaging further includes an ink layer.

7. The packaged food product of claim 6, wherein the ethylene vinyl alcohol layer is between the ink layer and the polyethylene film.

8. The packaged food product of claim 1, wherein the food packaging is completely void of polypropylene and polyethylene terephthalate.

9. A method of packaging a food product comprising:
locating the food product in an interior of a flexible film package established by a polyethylene laminate body including a main polyethylene film and an ethylene vinyl alcohol layer, with said flexible film package being entirely, readily recyclable; and
laser date coding the flexible film package by laser etching the ethylene vinyl alcohol layer.

10. The method of claim 9, wherein the flexible film package is established with the ethylene vinyl alcohol layer as an outermost layer.

11. The method of claim 9, wherein the flexible film package is established with the ethylene vinyl alcohol layer having a thickness which is no greater than 5% of a thickness of the flexible film package.

12. The method of claim 9, wherein the main polyethylene film is formed of oriented polyethylene (OPE), biaxially oriented polyethylene (BOPE), machine direction oriented polyethylene (MDOPE), Blown PE or Cast PE.

13. The method of claim 12, wherein the flexible film package consists of the main polyethylene film and the ethylene vinyl alcohol layer.

14. The method of claim 12, wherein the flexible film package further includes an ink layer.

15. The method of claim 14, wherein the flexible film package is formed with the ethylene vinyl alcohol layer between the ink layer and the polyethylene film.

16. The method of claim 9, wherein the flexible food package is completely void of polypropylene and polyethylene terephthalate.

17. The method of claim 9, wherein laser etching the ethylene vinyl alcohol layer damages a crystallinity structure of the ethylene vinyl alcohol.
